(19) United States
(12) Patent Application Publication
(10) Pub. No.: US 2026/0313282 A1
(43) Pub. Date: Oct. 8, 2026

(54) METHOD AND APPARATUS OF PROVIDING SERVICE, ELECTRONIC DEVICE, STORAGE MEDIUM, AND COMPUTER PROGRAM PRODUCT

(71) Applicant: Samsung Electronics Co., Ltd., Suwon-si (KR)

(72) Inventors: Yajun Zhi, Xi'An (CN); Fei Wang, Xi'An (CN); Kun Wang, Xi'An (CN); Dong Xu, Xi'An (CN)

(21) Appl. No.: 19/186,078

(22) Filed: Apr. 22, 2025

(30) Foreign Application Priority Data
Apr. 7, 2025 (CN) 202510429765.5

(51) Int. Cl. H04R 1/10; G06F 3/0346

(52) U.S. Cl. CPC H04R 1/1041; G06F 3/0346

(57) ABSTRACT

The present disclosure relates to a method and device of providing a service, an electronic apparatus, a storage medium and a computer program product, including: collecting external audio data and user motion inertial data; acquiring an audio level corresponding to the external audio data and a motion level corresponding to the user motion inertial data; determining a target scene where the user is currently located based on the acquired audio level, the acquired motion level and a preset correspondence; acquiring an external environment feature value and/or a user behavior feature value in the target scene; and providing the user with a service associated with the external environment feature value and/or the user behavior feature value. In this way, users may be provided with services by comprehensively considering the external audio data and the user motion inertial data, the types of data on which the services are provided based are more abundant, and the data contents are more comprehensive. This may reduce the phenomenon of misjudgment to a greater extent, further ensure that the users are provided with services that can satisfy the actual needs of the users, and may improve service effect.

### CROSS-REFERENCE TO RELATED APPLICATIONS

This application claims priority to Chinese Patent Application No. 202510429765.5 filed on Apr. 7, 2025, the entire contents of which are incorporated herein by reference.

### TECHNICAL FIELD

The present disclosure relates to a field of computer technology, and more particularly, relates to a method and apparatus of providing service, an electronic device, a storage medium, and a computer program product.

### BACKGROUND

In work and life, users may use earphones to have conversations and receive audios. In addition, since the earphones are small in size and easy to carry, pairing the earphones with mobile phones has become the choice of most users. The earphones may also be divided into wired earphones and wireless earphones, wherein True Wireless Stereo (TWS) earphones refer to earphones without traditional cables, including Bluetooth earphones, infrared earphones, and so on.

With the development of science and technology, in addition to basic dialogue functions and audio playback functions, the earphones may also perceive surrounding environmental data, human body data, etc., and then may provide users with other types of services based on the perceived data, such as heart rate monitoring services, abnormal condition monitoring services, etc.

However, in the related art, only specific data types are generally collected to provide services to users. Since types of data that the provided services are based on are relatively single, misjudgment may occur, making it difficult to provide users with services that satisfy the actual needs of the users, resulting in poor service effect.

### SUMMARY

The present disclosure provides a method and apparatus of providing a service, an electronic device, a storage medium, and a computer program product to help provide users with services that may satisfy the actual needs of the users, resulting in improved service effectiveness.

According to a first aspect of embodiments of the present disclosure, a method of providing a service applied to earphones includes: collecting external audio data and user motion inertial data; determining an audio level corresponding to the external audio data, and determining a motion level corresponding to the user motion inertial data; determining a target scene where a user is currently located based on the determined audio level, the determined motion level and a preset correspondence, wherein the preset correspondence is a correspondence between a preset audio level, a preset motion level and a preset scene; acquiring an external environment feature value and/or a user behavior feature value in the target scene; and providing the user with a service associated with the external environment feature value and/or the user behavior feature value.

In some embodiments, the determining the audio level corresponding to the external audio data, includes: extracting a loudness feature value and/or a noise feature value from the external audio data; and determining a loudness level corresponding to the external audio data based on the loudness feature value, and/or determining a noise level corresponding to the external audio data based on the noise feature value, wherein the greater the loudness feature value, the higher the loudness level, and the greater the noise feature value, the higher the noise level.

In some embodiments, a number of the earphones is two, and the collecting the external audio data and the user motion inertial data includes: collecting the external audio data and the user motion inertial data for each of the two earphones; before determining the loudness level corresponding to the external audio data based on the loudness feature value, performing fusion calibration on loudness feature values respectively corresponding to the two earphones to obtain a fused loudness feature value, and/or performing fusion calibration on noise feature values respectively corresponding to the two earphones to obtain a fused noise feature value. The determining the loudness level corresponding to the external audio data based on the loudness feature value, and/or the determining the noise level corresponding to the external audio data based on the noise feature value, includes determining the loudness level corresponding to the external audio data based on the fused loudness feature value, and/or determining the noise level corresponding to the external audio data based on the fused noise feature value.

In some embodiments, a method for the fusion calibration includes: averaging the feature values respectively corresponding to the two earphones to take an obtained average value as a fused feature value; or in the case where a fluctuation amplitude of the feature values collected by a first earphone of the two earphones is greater than or equal to a preset fluctuation threshold and a fluctuation amplitude of the feature values collected by a second earphone of the two earphones is less than the preset fluctuation threshold, discarding the feature values collected by the first earphone, and using the feature values collected by the second earphone as the fused feature values; or in the case where a change trend of the feature values collected by the first earphone is opposite to a historical change trend and a change trend of the feature values collected by the second earphone is the same as the historical change trend, discarding the feature values collected by the first earphone, and using the feature values collected by the second earphone as the fused feature values, wherein the historical change trend is a change trend of feature values collected in a historical sampling phase before a current sampling phase of the earphones.

In some embodiments, the determining the target scene where the user is currently located based on the acquired audio level, the acquired motion level, and the preset correspondence includes: comparing the acquired audio level with the preset audio level to obtain an audio level comparison result; comparing the acquired motion level with the preset motion level to obtain a motion level comparison result; and determining the target scene in which the user is currently located based on the audio level comparison result, the motion level comparison result and the preset correspondence.

In some embodiments, the collecting the external audio data and the user motion inertial data includes: collecting the external audio data and the user motion inertial data at a first sampling frequency; before acquiring an audio level corresponding to the external audio data, and acquiring a motion level corresponding to the user motion inertial data, further including: determining a change rate of the user motion inertial data collected at the first sampling frequency; in the case where the change rate of the user motion inertial data is greater than or equal to a preset rate threshold, collecting the external audio data and the user motion inertial data at a second sampling frequency, wherein the second sampling frequency is greater than the first sampling frequency; and the acquiring the audio level corresponding to the external audio data, and the acquiring the motion level corresponding to the user motion inertial data includes: acquiring an audio level corresponding to the external audio data collected at the second sampling frequency, and acquire a motion level corresponding to the user motion inertial data collected at the second sampling frequency.

According to some embodiments, when the number of the earphones is two, and the acquiring the audio level corresponding to the external audio data, and the determining the motion level corresponding to the user motion inertial data, include: using a first earphone of the two earphones to determine the audio level corresponding to the external audio data, and acquire the motion level corresponding to the user motion inertial data; and in the case where it is detected that a target situation in which data processing cannot be performed happens to the first earphone, using a second earphone of the two earphones to determine the audio level corresponding to the external audio data, and determine the motion level corresponding to the user motion inertial data.

According to some embodiments, the target situation where the data processing cannot be performed includes at least one of: a state of the first earphone changing from a worn state to a non-worn state, and a power amount of the first earphone being lower than a preset power amount threshold.

According to some embodiments, the collecting the external audio data and the user motion inertial data includes: receiving the external audio data and the user motion inertial data collected by a user terminal.

According to some embodiments, the providing the user with the service associated with the external environment feature value and/or the user behavior feature value includes: in the case where the external environment feature value is greater than or equal to a preset environment feature threshold, and/or in the case where the user behavior feature value is greater than or equal to a preset behavior feature threshold, providing the user with the service associated with the external environment feature value and/or the user behavior feature value.

According to some embodiments, the external environment feature value includes: an external audio data feature value, and a distance feature value between the earphones and a user terminal.

According to a second aspect of the embodiments of the present disclosure, an apparatus for providing a service applied to earphones includes: a first collection module configured to collect external audio data and user motion inertial data; a level determining module configured to determine an audio level corresponding to the external audio data, and determine a motion level corresponding to the user motion inertial data; a scene determination module configured to determine a target scene in which a user is currently located based on the determined audio level, the determined motion level and a preset correspondence, wherein the preset correspondence is a correspondence between a preset audio level, a preset motion level and a preset scene; a feature value acquiring module configured to acquire an external environment feature value and/or a user behavior feature value in the target scene; and a service providing module configured to provide the user with a service associated with the external environment feature value and/or the user behavior feature value.

According to some embodiments, the level determining module is configured to: extract a loudness feature value and/or a noise feature value from the external audio data; and determine a loudness level corresponding to the external audio data based on the loudness feature value, and/or determine a noise level corresponding to the external audio data based on the noise feature value, wherein the greater the loudness feature value, the higher the loudness level, and the greater the noise feature value, the higher the noise level.

According to some embodiments, a number of earphones is two, and the first collection module is configured to: collect the external audio data and the user motion inertial data for each of the two earphones; the device of providing the service further includes: a fusion calibration module configured to perform fusion calibration on loudness feature values respectively corresponding to the two earphones to obtain a fused loudness feature value, and/or perform fusion calibration on noise feature values respectively corresponding to the two earphones to obtain a fused noise feature value; and the level determining module is configured to: determine the loudness level corresponding to the external audio data based on the fused loudness feature value, and/or determine the noise level corresponding to the external audio data based on the fused noise feature value.

According to some embodiments, the fusion calibration includes: averaging the feature values respectively corresponding to the two earphones to take an obtained average value as a fused feature value; or in the case where a fluctuation amplitude of the feature values collected by a first earphone of the two earphones is greater than or equal to a preset fluctuation threshold and a fluctuation amplitude of the feature values collected by a second earphone of the two earphones is less than the preset fluctuation threshold, discarding the feature values collected by the first earphone, and taking the feature values collected by the second earphone as the fused feature values; or in the case where a change trend of the feature values collected by the first earphone is opposite to a historical change trend and a change trend of the feature values collected by the second earphone is the same as the historical change trend, discarding the feature values collected by the first earphone, and taking the feature values collected by the second earphone as the fused feature values, wherein the historical change trend is a change trend of feature values collected in a historical sampling phase before a current sampling phase of the earphones.

According to some embodiments, the scene determination module is configured to: compare the determined audio level with the preset audio level to obtain an audio level comparison result; compare the determined motion level with the preset motion level to obtain a motion level comparison result; and determine the target scene in which the user is currently located based on the audio level comparison result, the motion level comparison result and the preset correspondence.

According to some embodiments, the first collection module is configured to: collect the external audio data and the user motion inertial data at a first sampling frequency; the apparatus of providing the service further includes: a change rate determination module configured to determine a change rate of the user motion inertial data collected at the first sampling frequency; and a second collection module configured to, in the case where the change rate of the user motion inertial data is greater than or equal to a preset rate threshold, collect the external audio data and the user motion inertial data at a second sampling frequency, wherein the second sampling frequency is greater than the first sampling frequency; and the level determining module is configured to: determine an audio level corresponding to the external audio data collected at the second sampling frequency, and determine a motion level corresponding to the user motion inertial data collected at the second sampling frequency.

According to some embodiments, the earphones include two earphones, and the level determining module is configured to: use a first earphone of the two earphones to determine the audio level corresponding to the external audio data, and determine the motion level corresponding to the user motion inertial data; and in the case where it is detected that a target situation in which data processing cannot be performed has happened to the first earphone, use a second earphone of the two earphones to determine the audio level corresponding to the external audio data, and determine the motion level corresponding to the user motion inertial data.

According to some embodiments, the target situation in which the data processing cannot be performed is at least one of the following situations: a state of the first earphone changing from a worn state to a non-worn state, and a power amount of the first earphone being lower than a preset power amount threshold.

According to some embodiments, the first collection module is configured to: receive the external audio data and the user motion inertial data collected by a user terminal.

According to some embodiments, the service providing module is configured to: in the case where the external environment feature value is greater than or equal to a preset environment feature threshold, and/or in the case where the user behavior feature value is greater than or equal to a preset behavior feature threshold, provide the user with the service associated with the external environment feature value and/or the user behavior feature value.

According to some embodiments, the external environment feature value includes: an external audio data feature value, and a distance feature value between the earphones and a user terminal.

According to a third aspect of the embodiments of the present disclosure, an electronic device includes: a processor; and a memory for storing instructions executable by the processor, wherein the processor is configured to execute the instructions to implement the method of providing the service according to the present disclosure.

According to a fourth aspect of the embodiments of the present disclosure, a computer readable storage medium, includes instructions that, when executed by a processor of an electronic apparatus, enable the electronic apparatus to execute the method of providing the service according to the present disclosure.

According to a fifth aspect of the embodiments of the present disclosure, a computer program product including a computer program, when executed by a processor, implements the method of providing the service according to the present disclosure.

Some technical solutions provided by the embodiments of the present disclosure at least bring following advantageous effects:

In the present disclosure, users may be provided with services by comprehensively considering the external audio data and the user motion inertial data, the types of data on which the service is provided based are more abundant, and the data contents are more comprehensive. This may reduce the phenomenon of misjudgment to a greater extent, further ensure that the users are provided with services that can satisfy the actual needs of the users, and may improve service effect.

It should be understood that the above general description and the following detail description are merely exemplary and illustrative without limiting the present disclosure.

### BRIEF DESCRIPTION OF DRAWINGS

The drawings here are incorporated into the description and constitute a part of the description, illustrate embodiments conforming to the present disclosure, explain a principle of the present disclosure together with the description, and do not constitute inappropriate definition for the present disclosure.

FIG. 1 is a flowchart illustrating a method of providing a service according to an exemplary embodiment of the present disclosure;

FIG. 2 is a schematic diagram illustrating a structure of earphones according to exemplary embodiments of the present disclosure;

FIG. 3 is a schematic diagram illustrating a processing flow of multi-mode perception data according to an exemplary embodiment of the present disclosure;

FIG. 4 is a schematic diagram illustrating a flow of earphones collecting external audio data using a terminal according to an exemplary embodiment of the present disclosure;

FIG. 5 is a schematic diagram illustrating a flow of synchronous sampling and role exchange between earphones at two ends according to exemplary embodiments of the present disclosure;

FIG. 6 is a schematic diagram illustrating performing audio sampling at a rate of 1 KHz according to an exemplary embodiment of the present disclosure;

FIG. 7 is a schematic diagram illustrating extracting noise data from external audio data according to an exemplary embodiment of the present disclosure;

FIG. 8 is a flowchart illustrating specific implementation of a method of providing a service according to an exemplary embodiment of the present disclosure;

FIG. 9 is a flowchart illustrating specific implementation of outputting a notification message to a user according to an exemplary embodiment of the present disclosure;

FIG. 10 is a block diagram illustrating an apparatus of providing a service according to an exemplary embodiment of the present disclosure; and

FIG. 11 is a block diagram illustrating an electronic device according to an exemplary embodiment of the present disclosure.

### DETAILED DESCRIPTION OF EMBODIMENTS

In order to enable those ordinarily skilled in the art to understand the technical solutions of the present disclosure better, hereinafter, the technical solutions in the embodiments of the present disclosure will be described clearly and completely in conjunction with the drawings.

It should be explained that terms “first”, “second” and the like in the description and the claims as well as the drawings of the present disclosure are used to distinguish similar objects, and are not necessarily used to describe specific order or sequence. It should be understood that the data used in this way can be interchanged under appropriate circumstances so that the embodiments of the present disclosure described herein can be implemented in an order other than those illustrated or described herein. Also, It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

As used herein, the term “and/or” includes any and all combinations of one or more of the associated listed items and may be abbreviated as “/”.

Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

Terms such as “same,” “equal,” “planar,” “coplanar,” “parallel,” and “perpendicular,” as used herein encompass identicality or near identicality including variations that may occur resulting from conventional manufacturing processes. The term “substantially” may be used herein to emphasize this meaning, unless the context or other statements indicate otherwise.

Implementation manners described in the following embodiments do not represent all of the implementation manners that are consistent with the present disclosure. On the contrary, they are merely examples of devices and methods consistent with some aspects of the present disclosure as described in detail in the appended claims.

It should be explained here that “at least one of several items” appearing in the present disclosure is intended to include these three parallel situations: “any one of the several items”, “a combination of any multiple of the several items”, and “the totality of the several items”. For example, “including at least one of A and B” for example includes the following three parallel situations: (1) including A; (2) including B; and (3) including A and B. For another example, “executing at least one of step 1 and step 2” for example represents the following three parallel situations: (1) executing step 1; (2) executing step 2; and (3) executing step 1 and step 2.

Earphones include ear- or head-mounted devices that output audio signals through speakers. Earphones may be in the form of ear buds, such as small ear-mounted devices that fit into and are supported by, an outer portion the ear canal, as well as headphones, which are placed over the outside of the outer ear. Devices such as earphones, which output audio signals through a speaker and are mounted in or on the ear, may be generally described as ear-mounted audio speaker devices. These ear-mounted audio speaker devices may be wired or wireless. At present, earphones are becoming increasingly popular, and in work and life, users are wearing earphones for longer periods of time. Earphones have become one of the most important personal electronic apparatuses besides mobile phones. In addition to basic telephone service functions and audio playback functions, earphones may also perceive surrounding environmental data, human body data, etc., and then may provide users with other types of services based on the perceived data, such as heart rate monitoring services, abnormal condition monitoring services, etc.

However, in the related art, only specific types of data are generally collected to provide services to users. Since the types of data on which the provided services are based are relatively single, misjudgment may occur, making it difficult to provide users with services that satisfy the actual needs of the users, resulting in poor service effectiveness.

In order to address the above problems existing in the related art, a method and apparatus of providing a service, an electronic device, a storage medium and a computer program product provided by the present disclosure may provide users with services by comprehensively considering the external audio data and the user motion inertial data. As a result, the types of data on which the provided services are based are more abundant, and the data contents are more comprehensive. This may reduce the phenomenon of misjudgment to a greater extent, further ensure that the users are provided with services that can satisfy the actual needs of the users, and may improve service effect.

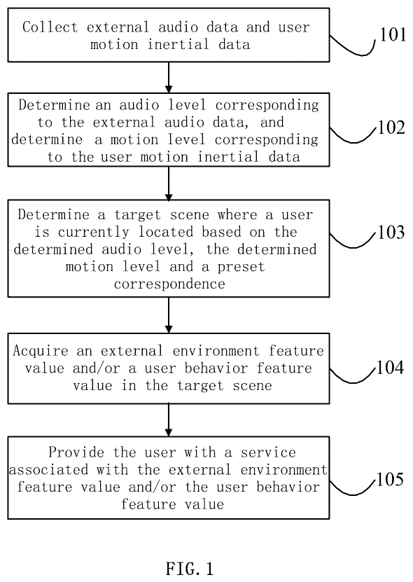

FIG. 1 is a flowchart illustrating a method of providing a service according to an exemplary embodiment of the present disclosure.

Referring to FIG. 1, in step 101, external audio data and user motion inertial data may be collected.

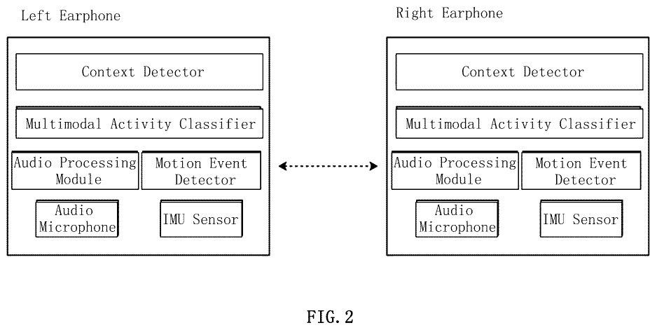

FIG. 2 is a schematic diagram illustrating a structure of earphones according to exemplary embodiments of the present disclosure. Referring to FIG. 2, each of the earphones of the present disclosure may mainly be composed of an inertial measurement unit (IMU) sensor, an audio microphone, an audio processing module, a motion event detector, a multimodal activity classifier, and a context detector. The various modules, detectors, classifiers, controllers, and other components described with ~er can include one or more of the following components: at least one logic chip configured to execute computer program instructions to perform various processes and methods, random access memory (RAM) and read only memory (ROM) configured to access and store data and information and computer program instructions. One of more of these components may be implemented using a semiconductor chip or package. In addition, the earphones can include antennas, network interfaces that provide wireless and/or wire line digital and/or analog interface to one or more other devices or networks over one or more network connections (not shown), a power source that provides an appropriate alternating current (AC) or direct current (DC) to power one or more components, and a bus that allows communication among the various disclosed components.

In addition, the present disclosure may provide two earphones, i.e., a left earphone and a right earphone, with the same structure for the left and right earphones. During a running cycle, one earphone may act as a primary role to run a multi-mode data processing flow, while the other earphone may act as a secondary device role. For example, the other earphone may only perform some auxiliary tasks or be in a state of waiting to perform tasks. The “auxiliary tasks” may be, for example, collecting external audio data and user motion inertial data, and the like.

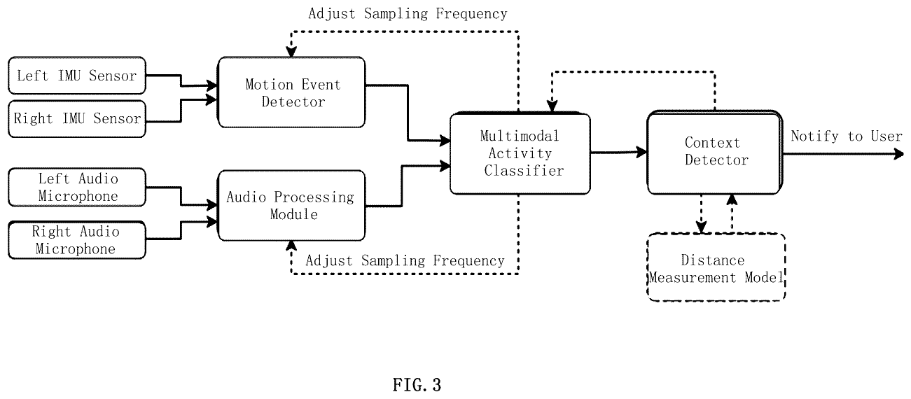

FIG. 3 is a schematic diagram illustrating a processing flow of multi-mode perception data according to an exemplary embodiment of the present disclosure. Referring to FIG. 3, the left earphone and the right earphone may each have an IMU sensor, and the IMU sensor may be used to collect user motion inertial data, wherein the “user motion inertial data” may include acceleration data in three directions of x-axis, y-axis, and z-axis.

Furthermore, when a change rate of the user motion inertial data is lower than a preset rate threshold, it indicates that the user is currently in a low-speed motion state and high sampling accuracy may not be required. Therefore, at this time, the user motion inertial data may be sampled at a lower frequency. For example, the “lower frequency” may be but is not limited to: 5 Hz, and may in some cases be any value including and between 2 Hz and 10 Hz, such as a whole number value from 2 Hz to 10 Hz. When the change rate of the user motion inertial data is greater than or equal to the preset rate threshold, it indicates that the user is currently in a high-speed motion state, for example, the user is currently in a fast-moving scene and high sampling accuracy is desirable or required. Therefore, at this time, the user motion inertial data may be sampled at a higher frequency. For example, the “higher frequency” may be but is not limited to: 50 Hz, and may in some cases be any value including and between 30 Hz and 100 Hz, such as a whole number value from 30 Hz to 100 Hz.

Referring to FIG. 3, the left earphone and the right earphone may each have an audio microphone, and the left and right audio microphones may perform time-sharing/simultaneous sampling measurement based on a current motion state of the user. For example, a sampling frequency and a sampling mode of the audio microphone may be dynamically adjusted based on the current motion state of the user. For example, when the audio processing module needs to perform fuse localization on external environment sound, dual-earphone audio microphone sampling may be started, and an auxiliary decision for environment switching during user's movement may be performed based on a difference between decibels of audio signals sampled by the left and right audio microphones at both ends of the human ears. For example, a sampling rate of the audio may vary and have a value between 125 Hz and 1 KHz.

Referring to FIG. 3, the motion event detector may mainly monitor user activity events based on an IMU data stream. Specifically, the motion event detector may normalize the user motion inertial data, e.g., the acceleration data, collected by the IMU sensor, so that variation ranges of values in the x-axis, y-axis and z-axis are between −1 and +1. Then, three quantized acceleration data may be accumulated. When a summation Motion_data exceeds a threshold, it may be recorded as a sub-motion event. If several sub-motion events are detected within a window period, a motion level corresponding to an acceleration data summation may be acquired, and further the motion level may be transmitted to the multimodal activity classifier. The motion event detector may adjust a collection processing frequency of the IMU data in real time according to a request.

According to some embodiments, the acceleration data summation may be expressed by the following formula:

$$Motion . data = ( x + y + z ) * InvSqrt ( x * x + y * y + z * z )$$

Wherein, x is a quantitative result of acceleration measurement values of the IMU sensor on the x-axis, y is a quantitative result of acceleration measurement values of the IMU sensor on the y-axis, z is a quantitative result of acceleration measurement values of the IMU sensor on the z-axis (where the x, y, and z axes may refer to three axes perpendicular to each other that form a three-dimensional space—such as two perpendicular horizontal directions, and one vertical direction perpendicular to both horizontal directions), and InvSqrt is an inverse square root function used to calculate the inverse of the square root.

According to an exemplary embodiment of the present disclosure, external audio data and user motion inertial data collected by a user terminal may be received. Specifically, when earphones and a terminal are on a user's body at the same time, an environmental audio sampling ability and a motion inertia sampling ability of the terminal may be used to acquire IMU data and environmental sound data. Then, the terminal may transmit the collected IMU data and the environmental sound data to the earphones, and then the earphones perform a subsequent data processing process. At this time, the earphones may turn off the audio microphones and the IMU sensors, and as a result the earphones may stop collecting the external audio data and the user motion inertial data.

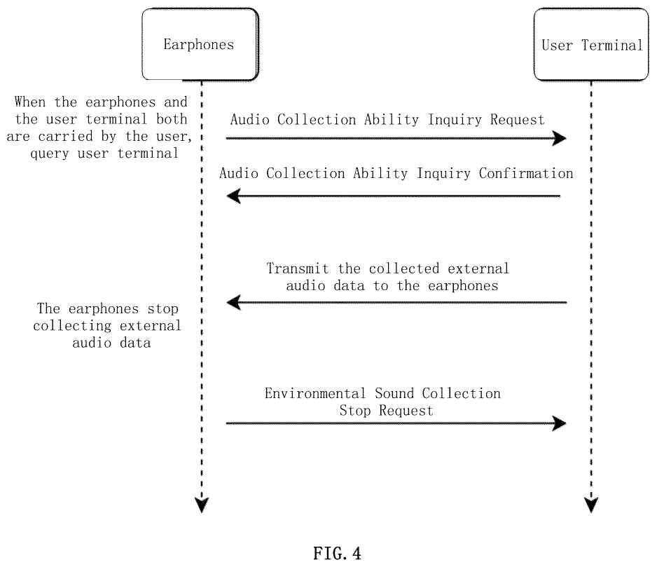

FIG. 4 is a schematic diagram illustrating a flow of earphones collecting external audio data using a terminal according to an exemplary embodiment of the present disclosure. Referring to FIG. 4, when both earphones and a terminal are carried by a user, the earphones may transmit an audio collection ability inquiry request to the terminal, and further the terminal may transmit an audio collection ability inquiry confirmation to the earphones to inform the earphone that the terminal of the user currently has audio collection ability. Next, the external audio data may be collected through the terminal, and the collected external audio data is transmitted to the earphones by the terminal. At this time, the earphones may stop collecting the external audio data. Moreover, when they do not need to collect the external audio data, the earphones may transmit an environmental sound collection stop request to the terminal to notify the terminal to stop collecting the external audio data.

Thus, when both the earphones and the terminal are carried by the user, the earphones may also use the terminal to collect the external audio data and user motion inertial data, so that the earphones do not need to perform a collection task, thereby reducing a task pressure on the earphones. In addition, if the collection ability of the terminal is higher than that of the earphones, an accuracy of data collection may further be improved to further improve a service effect.

Referring back to FIG. 1 in step 102, an audio level corresponding to the external audio data and a motion level corresponding to the user motion inertial data may be acquired.

According to an exemplary embodiment of the present disclosure, a loudness feature value and/or a noise feature value may be extracted from the external audio data. Then, the loudness level corresponding to the external audio data may be determined based on the loudness feature value; and/or, the noise level corresponding to the external audio data may be determined based on the noise feature value, wherein the greater the loudness feature value, the higher the loudness level; and the greater the noise feature value, the higher the noise level. Similarly, the motion level corresponding to the user motion inertial data may also be determined based on the acceleration data summation, wherein the greater the acceleration data summation is, the higher the motion level may be.

Referring back to FIG. 3, the audio processing module may convert the external audio data collected by the audio microphone, which is an external audio signal, into a simple linear frequency spectrum, and then may extract two perception feature values of the loudness feature value and the noise feature value. Then, the audio processing module may perform audio level quantization on these two perception feature values, and then may use the audio level obtained by quantization as input source data of the multimodal activity classifier. For example, the audio level may include but is not limited to: three levels of L0, L1 and L2.

In addition, the audio processing module may dynamically adjust an audio sample processing frequency and perform fusion calibration of the audio data according to a request. Specifically, when it needs to perform audio data calibration, the left and right earphones at both ends may be started to perform audio sampling simultaneously. When this occurs, the audio processing module may perform comparison calibration, i.e., fusion calibration, on audio data synchronously sampled by the left and right earphones, and then may transmit an audio fusion calibration result to the multimodal activity classifier.

Referring back to FIG. 3, the multimodal activity classifier may perform activity classification according to a plurality of motion levels output by the motion event detector and a plurality of audio levels output by the audio processing module. For example, the multimodal activity classifier may perform outlier elimination and smoothing processing on the received plurality of motion levels to obtain a final motion level; and the multimodal activity classifier may perform the outlier elimination and the smoothing processing on the received plurality of audio levels to obtain a final audio level.

According to an exemplary embodiment of the present disclosure, a random forest model may be used, and statistical features may be calculated based on the sampled and filtered IMU data stream and audio feature value data to train the random forest model, so as to deploy a lightweight multimodal activity classifier.

According to an exemplary embodiment of the present disclosure, the number of earphones may be two, and external audio data and user motion inertial data may be collected for each of the two earphones. Then, fusion calibration may be performed on loudness feature values respectively corresponding to the two earphones to obtain a fused loudness feature value, and/or fusion calibration may be performed on noise feature values respectively corresponding to the two earphones to obtain a fused noise feature value. Next, a loudness level corresponding to the external audio data may be determined based on the fused loudness feature value, and/or a noise level corresponding to the external audio data may be determined based on the fused noise feature value.

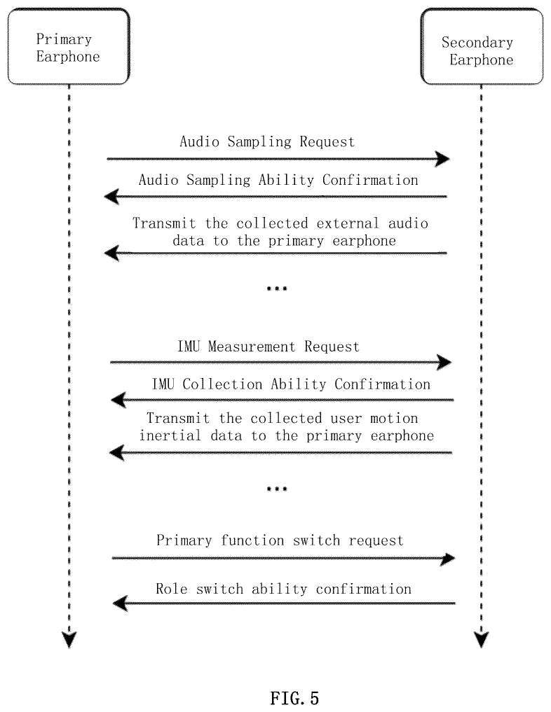

FIG. 5 is a schematic diagram illustrating a flow of synchronous sampling and role exchange between earphones at two ends according to exemplary embodiments of the present disclosure. Referring to FIG. 5, in the present disclosure, one earphone may be selected from the two earphones as a primary role to perform data processing. When a multimodal activity classifier determines that high-accuracy sampling needs to be performed, an audio sampling request may be initiated to a secondary earphone. Then, the secondary earphone transmits an audio sampling ability confirmation to the primary earphone after receiving the audio sampling request. Next, the secondary earphone may collect external audio data and transmits the collected external audio data to the primary earphone according to a time window.

Similarly, when the primary earphone needs to perform IMU measurement calibration, i.e., fusion calibration, it may transmit an IMU measurement request to the secondary earphone. Then, the secondary earphone transmits an IMU collection ability confirmation to the primary earphone. Next, the secondary earphone may collect user motion inertial data and transmits the collected user motion inertial data to the primary earphone. Then, the fusion calibration on the IMU sampling data may be performed by the primary earphone.

Thus, by performing the fusion calibration on the data collected by two earphones, an amount of data that is considered is larger, and data information is more comprehensive, so that this may ensure that the users may be provided with more accurate and more suitable services.

According to an exemplary embodiment of the present disclosure, a method for the fusion calibration may include: averaging feature values respectively corresponding to two earphones to take an obtained average value as a fused feature value. For example, assuming that audio microphones at both ends have collected external audio data 10 times, respectively, the audio processing module may extract 10 loudness feature values corresponding to the external audio data 10 times collected by the left audio microphone, and extract 10 loudness feature values corresponding to external audio data 10 times collected by the right audio microphone. Then, the audio processing module may correspondingly average the 10 loudness feature values corresponding to the left audio microphone and the 10 loudness feature values corresponding to the right audio microphone according to a sampling order, and then may obtain 10 loudness feature average values.

Thus, by means of averaging the audio data collected by the left and right earphones, comprehensively considering the audio data collected by the two earphones may be implemented to avoid a phenomenon in which poor service effectiveness is caused by performing data processing only based on the audio data collected by a single earphone. Therefore, by averaging the audio data, the earphones are capable of ensuring that more accurate services may be provided to the users.

According to an exemplary embodiment of the present disclosure, in the case where a fluctuation amplitude of the feature values collected by a first earphone of the two earphones is greater than or equal to a preset fluctuation threshold and a fluctuation amplitude of the feature values collected by a second earphone of the two earphones is less than the preset fluctuation threshold, the feature values collected by the first earphone may be discarded, and the feature values collected by the second earphone may be taken as the fused feature value.

For example, assuming that a fluctuation amplitude (e.g., a root mean square) of the 10 loudness feature values corresponding to the left earphone is greater than or equal to a preset fluctuation threshold and a fluctuation amplitude of the 10 loudness feature values (e.g., a root mean square) corresponding to the right earphone is less than the preset fluctuation threshold, the 10 loudness feature values corresponding to the left earphone may be discarded, and the 10 loudness feature values corresponding to the right earphone may be taken as a fused loudness feature value.

Thus, the audio data with a greater fluctuation amplitude may be discarded, and the data processing is only performed based on the audio data with a smaller fluctuation amplitude. As a result, the data processing may be only performed based on the relatively more stable audio data. Interference on the accuracy of data processing caused by too large or too small abnormal values may be avoided, and the earphones are further capable of ensuring the improvement of service effect.

According to an exemplary embodiment of the present disclosure, in the case where a change trend of the feature values collected by the first earphone is opposite to a historical change trend and a change trend of the feature values collected by the second earphone is the same as the historical change trend, the feature values collected by the first earphone may be discarded, and the feature values collected by the second earphone may be taken as fused feature values, wherein the historical change trend is a change trend of feature values collected in a historical sampling phase before a current sampling phase of the earphones, for example, the historical change trend is a change trend of prior values collected in a historical process.

As one example, in one embodiment, it is assumed that a change trend of prior loudness feature values collected in a historical process is monotonically increasing. Further, assuming that a change trend of the 10 loudness feature values corresponding to the left earphone is monotonically increasing, and a change trend of the 10 loudness feature values corresponding to the right earphone is monotonically decreasing, the 10 loudness feature values corresponding to the right earphone may be discarded, and the 10 loudness feature values corresponding to the right earphone may be taken as the fused loudness feature values.

Thus, since prior values in historical processes have a certain reference value, sampling values with a change trend opposite to a change trend of the historical prior values may be eliminated, and only sampling values with the same change trend as the historical change trend may be maintained for subsequent data processing. This may avoid the interference of abnormal sampling values on the accuracy of data processing and further improve service effectiveness.

According to an exemplary embodiment of the present disclosure, external audio data and user motion inertial data may be collected at a first sampling frequency. Then, a change rate of the user motion inertial data collected at the first sampling frequency may be determined. In the case where the change rate of the user motion inertial data is greater than or equal to a preset rate threshold, the external audio data and the user motion inertial data may be collected at a second sampling frequency, wherein the second sampling frequency is greater than the first sampling frequency. As a result, the data sampling may be performed at a higher sampling frequency. Next, an audio level corresponding to the external audio data collected at the second sampling frequency, and a motion level corresponding to the user motion inertial data collected at the second sampling frequency may be acquired.

Specifically, if it is detected that the change rate of the user motion inertial data suddenly increases, it indicates that a user has very likely changed from a walking state to a running state. As the user moves rapidly, an external environment state and a user motion state will change drastically. At this time, higher requirements for sampling accuracy are also put forward. Therefore, high-rate IMU sampling and high-rate environmental sound sampling may be triggered to ensure the higher sampling accuracy to further ensure providing more accurate services to the user. For example, if the context detector determines that the user is currently in a motion scene, a noise reduction service may be provided for which it is possible to allow the user to audibly perceive the external environment as clearly as possible, and to further enable the user to avoid obstacles timely to ensure the safety of the user.

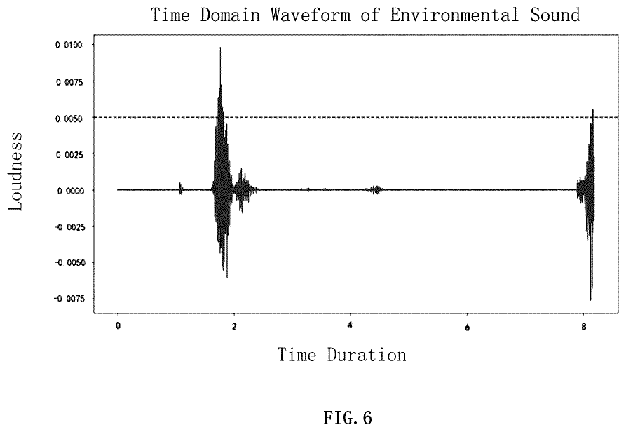

FIG. 6 is a schematic diagram illustrating performing audio sampling at a rate of 1 KHz according to an exemplary embodiment of the present disclosure. Referring to FIG. 6, a horizontal dotted line may represent an audio level L0. When it is detected that an audio loudness detected within a window period exceeds the audio level L0, it may be labeled as one audio sampling data exceeding the audio level L0.

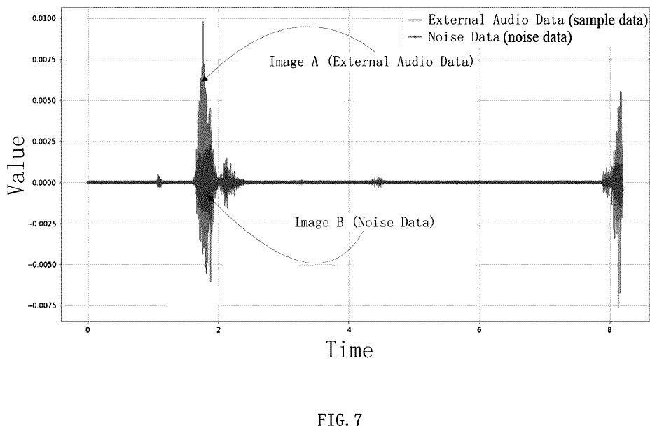

FIG. 7 is a schematic diagram illustrating extracting noise data from external audio data according to an exemplary embodiment of the present disclosure. Referring to FIG. 7, an image A is the collected external audio data, and an image B is noise data extracted from the external audio data.

According to an exemplary embodiment of the present disclosure, as described previously, the number of the earphones may be two. A first earphone of the two earphones may be used to acquire the audio level corresponding to the external audio data, and acquire the motion level corresponding to the user motion inertial data. However, if it is detected that a target situation in which data processing cannot be performed happens to the first earphone, a second earphone of the two earphones may be used to acquire the audio level corresponding to the external audio data, and acquire the motion level corresponding to the user motion inertial data.

Specifically, referring back to FIG. 5, when the primary earphone needs to perform role switching, a primary function switch request may be initiated to the secondary earphone. The secondary earphone may transmit a role switch ability confirmation to the primary earphone after receiving the primary function switch request, and then the secondary earphone may be converted to be a primary earphone to perform data processing process. Moreover, the original primary earphone may be converted to be a secondary earphone or even in a standby state.

Thus, by such a way of setting the primary and secondary earphones, one earphone may be used to perform the main data processing process, and the other earphone may be used to perform simple data processing or to be even in a standby state. This may effectively reduce power consumption. In addition, by providing a method of allowing the role switching between the primary and secondary earphones, the primary-secondary role switch may be performed in time in the case where the current primary earphone does not or cannot work. The other earphone may be converted to be a primary earphone in time to take over a task of the primary earphone that does not currently work, and as a result, alternative running of two earphones may be implemented based on an actual situation. A phenomenon of sudden interruption of data processing caused by the malfunction of one earphone may be avoided, further continuous execution of data collection monitoring services may be ensured, thereby improving stability and anti-interference ability during the service provision process.

According to an exemplary embodiment of the present disclosure, a target situation in which the data processing cannot be performed may be but is not limited to the following situations: a state of the first earphone changing from a worn state to a non-worn state, for example, the state of the first earphone changing from the worn state to a state of being taken off by a user; or a power amount (e.g., remaining battery power) of the first earphone being lower than a preset power amount threshold.

In step 103, a target scene where a user is currently located may be determined based on the acquired audio level, the acquired motion level and a preset correspondence, wherein the preset correspondence may be a correspondence between a preset audio level, a preset motion level and a preset scene.

For example, in one embodiment, the “preset audio level” and the “preset motion level” each may contain three levels, which are L0, L1 and L2, respectively. The “preset scene” may be but is not limited to following scenes: reading, office working, moving, sports and others.

According to an exemplary embodiment of the present disclosure, the acquired audio level may be compared with the preset audio level to obtain an audio level comparison result; and the acquired motion level may be compared with the preset motion level to obtain a motion level comparison result. Then, the target scene where the user is currently located may be determined based on the audio level comparison result, the motion level comparison result and the preset correspondence.

Specifically, referring back to FIG. 3, the context detector may infer a scene where the user is currently located according to activity attributes output by the multimodal activity classifier. Specifically, the context detector may use a scrolling window consisting of N sets of data instances, wherein each set of data may be used for a voting decision of a current context scene. If the context detector decides that the user is currently located at a certain preset scene, the context detector may switch to a corresponding context state and then count the user's activity data in the current state. When data satisfying a preset threshold is generated, a notification message may be output to the user or a corresponding service is automatically performed.

A following table shows the preset correspondence used by the context detector of the earphones, which is a relation mapping table. The relation mapping table may match a scene corresponding to a decision through definitions of indicators in three dimensions. In these preset scenes contained in the relation mapping table, the external environment feature and the user behavior feature may be monitored. When the monitored feature value triggers a threshold, a notification message may be sent to the user or the corresponding service may be automatically performed. The loudness level, noise level, and motion level, may each be an indicator that indicates a relative loudness, noise, or motion based on a pre-set scale. Each level may correspond to a particular range of respective loudness feature values, noise feature values, and motion inertial data, respectively. For example, the loudness feature value may be the volume of the sound, the noise feature value may be a frequency range of noise, and the motion inertial data may be an acceleration amount, speed, or other measure of motion. The loudness level, noise level, and motion level may be stored in a memory, for example, to serve as a loudness level indicator, noise level indicator, and motion level indicator, to represent a loudness level among a pre-determined set of loudness levels (each set including a range of loudness feature values from among a total range of values for all of the loudness levels combined), a noise level among a pre-determined set of noise levels (each set including a range of noise feature values from among a total range of values for all of the noise levels combined), and a motion level among a pre-determined set of motion levels (each set including a range of motion inertial data within a particular range). Values that map the above-described ranges to the above-described levels may be stored in a memory in order to correlate the ranges to their pre-determined levels, as can be seen below.

| Activity Metric | Context | Notification Type |
|---|---|---|
| Loudness level < L0 | Reading | Long sitting reminder |
| Noise level < L0 | | Noise cancellation reminder |
| Motion level < L0 | | |
| Loudness level < L1 | Office | Conversation Awareness |
| Noise level < L1 | Working | Abnormal events record |
| Motion level < L1 | | |
| Loudness level < L2 | Moving | Phone loss prevention |
| Noise level < L2 | | Scenario change monitoring |
| Motion level < L1 | | |
| Loudness and Noise level | Sports | Phone loss prevention |
| any Motion level > L2 | | Intense exercise reminder |
| Loudness level, Noise | Others | Harmful health events notify |
| level or Motion level changed | | Abnormal events record |
| rapidly at window period | | Scenario change monitoring |

### Activity Perception Metric

| Data type | Range Description |
|---|---|
| Loudness_level | L0, the lowest sound signal strength, Quiet |
| | L1, middle level, Normal |
| | L2, the highest sound signal strength, Loudly |
| Noise_level | L0, the lowest sound signal strength |
| | L1, the middle level |
| | L2, the highest level |
| Motion_level | L0, the lowest motion value, no changed |
| | L1, the middle value, changed normally |
| | L2, the highest motion value, changed rapidly |

In step 104, an external environment feature value and/or a user behavior feature value in the target scene may be acquired.

According to an exemplary embodiment of the present disclosure, the external environment feature value may be or may include, for example: an external audio data feature value (e.g., a loudness level and/or frequency range of an external sound), a distance feature value between earphones and a user terminal, etc. The user behavior feature value may be or may include, for example, an indication of amount of movement of a user (e.g., an indicator of sitting, or walking, or running), etc.

In step 105, a user may be provided with a service associated with the external environment feature value and/or the user behavior feature value.

According to an exemplary embodiment of the present disclosure, in the case where the external environment feature value is greater than or equal to a preset environment feature threshold, and/or in the case where the user behavior feature value is greater than or equal to a preset behavior feature threshold, the user may be provided with the service associated with the external environment feature value and/or the user behavior feature value.

For example, in the case where a user is currently in a reading scene, when it is detected that the user is sitting for a long time, a notification message for long sitting reminder may be sent to the user; in the case where the user is currently in an office working scene, when it is detected that there is another person having conversations with the current user, a conversation awareness may be output to the current user to remind the current user to reply to the conversations of the other person in time, or a volume of an audio currently played by the earphones may be decreased automatically to enable the user to hear the conversation contents between the other user and himself/herself more clearly; in the case where the user is in a moving scene, when it is detected that a distance between the earphones and the user terminal is relatively far, a notification message for phone loss prevention may be sent to the user; in the case where a user is currently in a sports scene, when it is detected that the user is excising intensely, a notification message that the intense exercise is harmful to the health may be sent to the user; and in the case where the user is currently in other scenes, when it is detected that the external audio is harsh and urgent, a harmful health event notification message may be sent to the user, for example, a notification message that an emergency situation occurs currently may be sent to the user and the like.

In the present disclosure, a multi-mode active perception monitoring method based on earphones is proposed, which may collect two types of data based on IMU sensors and audio microphones in the earphones, then perform fusion processing on the collected two types of data, and perceive an external environment in real time based on fusion processing results to provide active perception services to users. Since the types of data on which the provided services are based are more abundant, and the data contents are more comprehensive, the phenomenon of misjudgment may be reduced to a greater extent. In addition users are provided with services that can satisfy the actual needs of the users, and service effect may be improved.

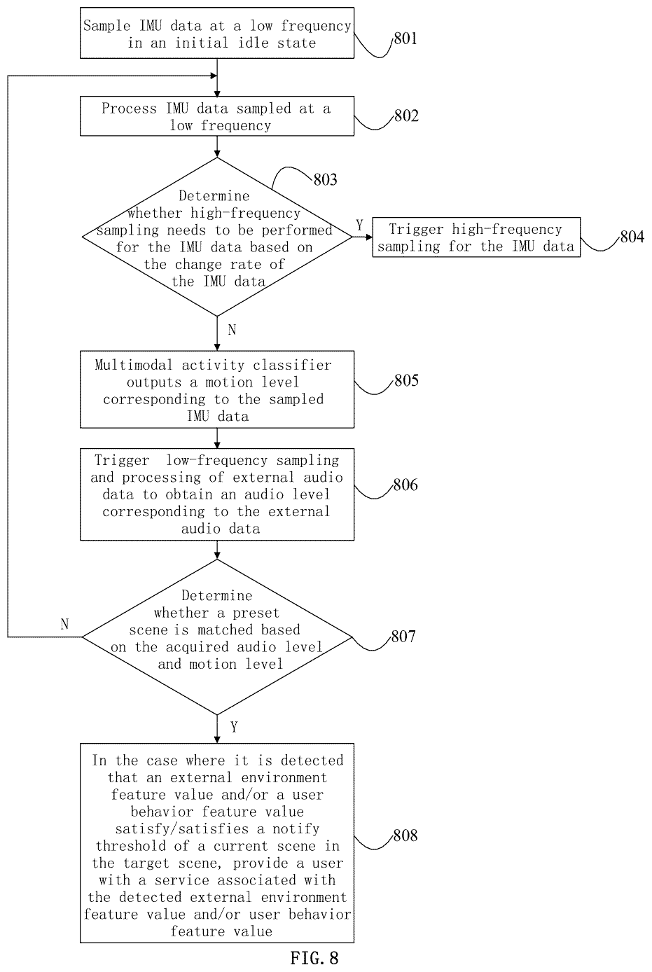

FIG. 8 is a flowchart illustrating specific implementation of a method of providing a service according to an exemplary embodiment of the present disclosure.

Referring to FIG. 8, in step 801, IMU data may be sampled at a low frequency in an initial idle state.

In step 802, the IMU data sampled at the low frequency is processed. For example, a change rate of the IMU data sampled at the low frequency may be calculated.

In step 803, whether high-frequency sampling needs to be performed for the IMU data is determined based on the change rate of the IMU data. Moreover, in the case where the change rate of the IMU data is greater than or equal to a preset rate threshold, step 804 may be performed; otherwise, in the case where the change rate of the IMU data is less than the preset rate threshold, step 805 may be performed.

In step 804, the high-frequency sampling for the IMU data may be triggered.

In step 805, the multimodal activity classifier outputs a motion level corresponding to the sampled IMU data.

In step 806, low-frequency sampling and processing of external audio data are triggered to obtain an audio level corresponding to the external audio data.

In step 807, whether a preset scene is matched is determined based on the acquired audio level and motion level. For example, a target scene where a user is currently located is determined based on the acquired audio level, the acquired motion level and a preset correspondence, wherein the preset correspondence is a correspondence between a preset audio level, a preset motion level, and a preset scene. For example, each preset scene may be associated with a certain combination of an audio level and a motion level. For each acquired audio level and acquired motion level, a comparison may be made to the preset audio levels and preset motion levels to find a matching pair, or closest matching pair of audio levels and preset motion levels, and a corresponding preset scene may be selected as the current scene based on the matching or closest matching preset audio level and preset motion level. If the preset scene can be matched, step 808 is performed; otherwise, if the preset scene cannot be matched, the process returns to perform step 802.

In step 808, in the case where it is detected that an external environment feature value and/or a user behavior feature value satisfy/satisfies (e.g., equals or exceeds) a notify threshold of a current scene in the target scene, a user may be provided with a service associated with the detected external environment feature value and/or user behavior feature value.

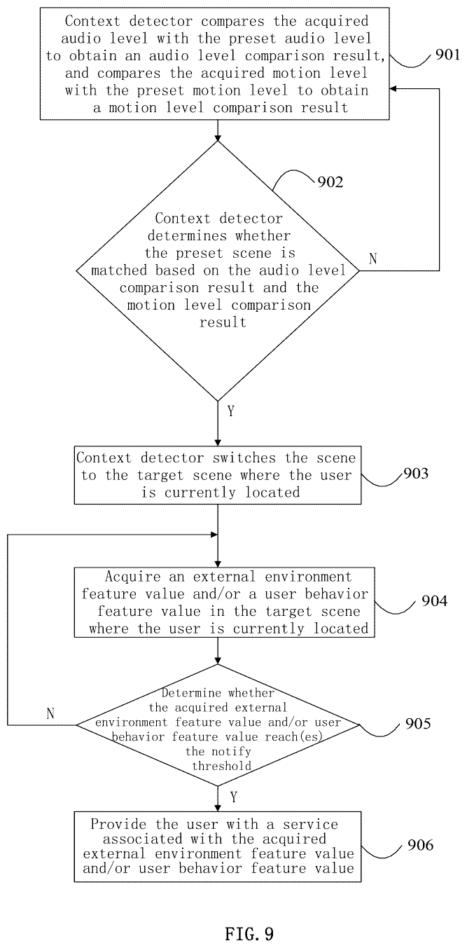

FIG. 9 is a flowchart illustrating specific implementation of outputting a notification message to a user according to an exemplary embodiment of the present disclosure.

Referring to FIG. 9, in step 901, the context detector compares the acquired audio level with the preset audio level to obtain an audio level comparison result, and compares the acquired motion level with the preset motion level to obtain a motion level comparison result.

In step 902, the context detector determines whether the preset scene is matched based on the audio level comparison result and the motion level comparison result. For example, the context detector determines the target scene where the user is currently located (e.g., a current scene) based on the audio level comparison result, the motion level comparison result and the preset correspondence. As described above, wherein the “preset correspondence” is a correspondence between a preset audio level, a preset motion level and a preset scene. In the case where the preset scene is matched based on the audio level comparison result and the motion level comparison result, step 903 is performed; otherwise, in the case where the preset scene is not matched based on the audio level comparison result and the motion level comparison result, the process returns to perform step 901.

In step 903, the context detector switches the scene to the target scene where the user is currently located.

In step 904, an external environment feature value and/or a user behavior feature value in the target scene may be acquired in the target scene where the user is currently located. For example, the external environment feature value may include but is not limited to: an external audio data feature value, and a distance feature value between earphones and a user terminal.

In step 905, whether the acquired external environment feature value and/or user behavior feature value reach(es) the notify threshold are/is determined. In the case where it is determined that the acquired external environment feature value and/or user behavior feature value reach(es) the notify threshold, step 906 is performed; otherwise, in the case where it is determined that the acquired external environment feature value and/or user behavior feature value do(es) not reach the notify threshold, it is returned to perform step 904.

In step 906, the user may be provided with a service associated with the acquired external environment feature value and/or user behavior feature value. For example, a notification message associated with the acquired external environment feature value and/or user behavior feature value may be output to the user.

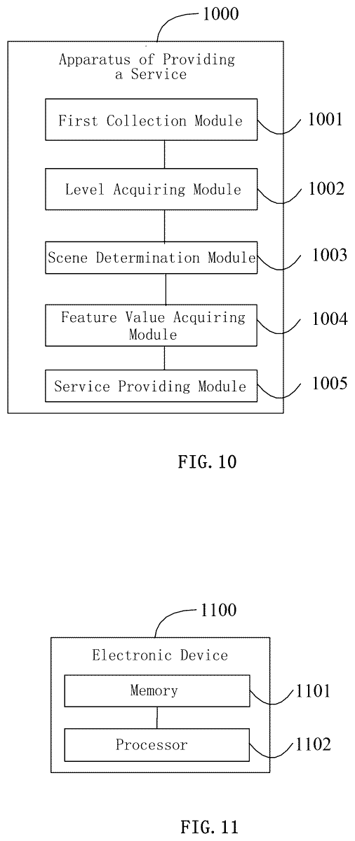

FIG. 10 is a block diagram illustrating an apparatus of providing a service according to an exemplary embodiment of the present disclosure.

Referring to FIG. 10, the apparatus of providing the service 1000 may include a first collection module 1001, a level acquiring module 1002, a scene determination module 1003, a feature value acquiring module 1004 and a service providing module 1005. The first collection module 1001, level acquiring module 1002, scene determination module 1003, feature value acquiring module 1004, and service providing module 1005 may each be implemented with hardware and with firmware and/or software such as computer program code, configured to perform the various functions described herein. The modules may be considered as separate modules that each perform a particular set of tasks to determine and generate one or more outputs based on one or more inputs, or one or more may be combined.

The first collection module 1001 may collect external audio data and user motion inertial data.

According to an exemplary embodiment of the present disclosure, the first collection module 1001 may receive external audio data and user motion inertial data collected by a user terminal. Specifically, the terminal and earphones may determine that they are on a user's body, for example, based on a communication between the devices (e.g., using Bluetooth or other communication protocols) that indicates a common motion of both devices combine with a particular amount of proximity. When earphones and a terminal are on a user's body at the same time, an environmental audio sampling ability and a motion inertia sampling ability of the terminal may be used to acquire IMU data and environmental sound data (e.g., through a microphone on the terminal and a gyroscope and/or accelerometer of the terminal). Then, the terminal may temporarily store and then transmit the collected IMU data and the environmental sound data to the earphones, and then the earphones perform subsequent data processing process. Therefore, in one embodiment, the collection module 1001 may acquire the IMU data and environmental sound data and temporarily store these data prior to transmitting the data to the earphones. At this time, the earphones may turn off the audio microphone and the IMU sensor. For example, the earphone may stop collecting the external audio data and the user motion inertial data.

Thus, when both the earphones and the terminal are carried by the user, the earphones may use the terminal to collect the external audio data and user motion inertial data, so that the earphones do not need to perform a collection task, thereby reducing a task pressure on the earphones. In addition, if the collection ability of the terminal is higher than that of the earphones, an accuracy of data collection may be improved to further improve a service effect.

The level acquiring module 1002, also described as a level determining module may acquire an audio level corresponding to the external audio data, and acquire a motion level corresponding to the user motion inertial data.

According to an exemplary embodiment of the present disclosure, the level acquiring module 1002 may extract a loudness feature value and/or a noise feature value from the external audio data. Then, the level acquiring module 1002 may determine a loudness level corresponding to the external audio data based on the loudness feature value (e.g., by using a mapping table), and/or, may determine the noise level corresponding to the external audio data based on the noise feature value (e.g., by using a mapping table), wherein the greater the loudness feature value, the higher the loudness level; and the greater the noise feature value, the higher the noise level. Similarly, the motion level corresponding to the user motion inertial data may also be determined based on the acceleration data summation, wherein the greater the acceleration data summation is, the higher the motion level may be. The determined levels may be temporarily stored for later use.

According to an exemplary embodiment of the present disclosure, the apparatus of providing the service 1000 may further include a fusion calibration module.

The number of earphones may be two, and the first collection module 1001 may collect external audio data and user motion inertial data for each of the two earphones. Then, a fusion calibration module may perform fusion calibration on loudness feature values respectively corresponding to the two earphones to obtain a fused loudness feature value, and/or may perform fusion calibration on noise feature values respectively corresponding to the two earphones to obtain a fused noise feature value. Next, the level acquiring module 1002 may determine a loudness level corresponding to the external audio data based on the fused loudness feature value, and/or determine a noise level corresponding to the external audio data based on the fused noise feature value. The loudness level and noise level may be stored in a memory, for example, to serve as a loudness level indicator and noise level indicator to represent a loudness level among a set of loudness levels and a noise level among a set of noise levels.

Thus, by performing the fusion calibration on the data collected by two earphones, an amount of data that is considered is larger, and data information is more comprehensive, so that this may ensure that the users may be provided with more accurate and more suitable services.

According to an exemplary embodiment of the present disclosure, a method for the fusion calibration may include averaging feature values respectively corresponding to two earphones to take an obtained average value as a fused feature value. For example, assuming that audio microphones at both ends have collected external audio data 10 times, respectively, the audio processing module may extract 10 loudness feature values corresponding to the external audio data 10 times collected by the left audio microphone, and extract 10 loudness feature values corresponding to external audio data 10 times collected by the right audio microphone. Then, the audio processing module may correspondingly average the 10 loudness feature values corresponding to the left audio microphone and the 10 loudness feature values corresponding to the right audio microphone according to a sampling order, and then may obtain 10 loudness feature average values, which may be stored in a memory.

Thus, by means of averaging the audio data collected by the left and right earphones, comprehensively considering the audio data collected by the two earphones may be implemented to avoid a phenomenon in which poor service effectiveness is caused by performing data processing only based on the audio data collected by a single earphone. Accordingly, more accurate services may be provided to the users.

According to an exemplary embodiment of the present disclosure, in the case where a fluctuation amplitude of feature values collected by a first earphone of the two earphones is greater than or equal to a preset fluctuation threshold and a fluctuation amplitude of feature values collected by a second earphone of the two earphones is less than the preset fluctuation threshold, the feature values collected by the first earphone may be discarded, and the feature values collected by the second earphone may be taken as fused feature values.

For example, assuming that a fluctuation amplitude of the 10 loudness feature values corresponding to the left earphone is greater than or equal to a preset fluctuation threshold and a fluctuation amplitude of the 10 loudness feature values corresponding to the right earphone is less than the preset fluctuation threshold, the 10 loudness feature values corresponding to the left earphone may be discarded, and the 10 loudness feature values corresponding to the right earphone may be taken as the fused loudness feature values.

Thus, the audio data with a greater fluctuation amplitude may be discarded, and the data processing is only performed based on the audio data with a smaller fluctuation amplitude, that is, the data processing may be only performed based on the relatively more stable audio data. Interference on the accuracy of data processing caused by too large or too small abnormal values may be avoided, and resulting in the improvement of service effect.

According to an exemplary embodiment of the present disclosure, in the case where a change trend of the feature values collected by the first earphone is opposite to a historical change trend and a change trend of the feature values collected by the second earphone is the same as the historical change trend, the feature values collected by the first earphone may be discarded, and the feature values collected by the second earphone may be taken as the fused feature value, wherein the historical change trend is a change trend of feature values collected in a historical sampling phase before a current sampling phase of the earphones, for example, the historical change trend is a change trend of prior values collected in a historical process.

For example, in one embodiment, it is assumed that a change trend of prior loudness feature values collected in a historical process is monotonically increasing. Further, assuming that a change trend of the 10 loudness feature values corresponding to the left earphone is monotonically increasing, and a change trend of the 10 loudness feature values corresponding to the right earphone is monotonically decreasing, the 10 loudness feature values corresponding to the right earphone may be discarded, and the 10 loudness feature values corresponding to the right earphone may be taken as a fused loudness feature value.

Thus, due to a reference value of prior values in historical processes, sampling values having a change trend opposite to the historical prior values may be eliminated, and only sampling values having the same change trend as the historical change trend may be maintained for subsequent data processing. This may avoid the interference of abnormal sampling values on the accuracy of data processing and further improve service effectiveness.

According to an exemplary embodiment of the present disclosure, the apparatus of providing the service 1000 may further include a change rate determination module and a second collection module.

The first collection module 1001 may collect external audio data and user motion inertial data at a first sampling frequency. Then, the change rate determination module may determine a change rate of the user motion inertial data collected at the first sampling frequency. In the case where the change rate of the user motion inertial data is greater than or equal to a preset rate threshold, the second change rate may collect the external audio data and the user motion inertial data at a second sampling frequency, wherein the second sampling frequency is greater than the first sampling frequency, and therefore, the data sampling may be performed at a higher sampling frequency. Next, the level acquiring module 1002 may acquire an audio level corresponding to the external audio data collected at the second sampling frequency, and a motion level corresponding to the user motion inertial data collected at the second sampling frequency.

Specifically, in some situations, if it is detected that the change rate of the user motion inertial data suddenly increases, may indicate that a user has changed from a walking state to a running state, or more generally from a low speed state to a high speed state. As the user moves rapidly, an external environment state and a user motion state will change drastically. Therefore, higher requirements for sampling accuracy may be needed, and high-rate IMU sampling and high-rate environmental sound sampling may be triggered to ensure the higher sampling accuracy to further ensure providing more accurate services to the user. For example, if the context detector determines that the user is currently in a motion scene, a noise reduction service may be provided, such that it is possible to allow the user to perceive the external environment as clearly as possible, and further enable the user to avoid obstacles timely to ensure the safety of the user.

According to an exemplary embodiment of the present disclosure, as described previously, the number of the earphones may be two. The level acquiring module 1002 may use a first earphone of the two earphones to acquire the audio level corresponding to the external audio data, and acquire the motion level corresponding to the user motion inertial data. However, in the case in which it is detected that a target situation in which data processing cannot be performed happens to the first earphone, the level acquiring module 1002 may use a second earphone of the two earphones to acquire the audio level corresponding to the external audio data, and acquire the motion level corresponding to the user motion inertial data.

Thus, by such a way of setting the primary and secondary earphones, the earphones may be configured such that only one earphone needs to be used to perform the main data processing process, and the other earphone can perform only simple data processing or even be in a standby state. A controller communicating with both earphones may control which earphone performs which functions. This may effectively reduce power consumption. In addition, by providing a method of allowing role switching between primary and secondary earphones, the primary-secondary role switch may be performed in a timely manner in the case in which the current primary earphone does not work properly. For example, the other earphone may be converted to be a primary earphone in time to take over a task of the primary earphone that does not currently work. As a result, alternative running of two earphones may be implemented based on an actual situation. A phenomenon of sudden interruption of data processing caused by the malfunction of one earphone may be avoided, and further continuous execution of data collection monitoring service may be ensured, thereby improving stability and anti-interference ability during the service provision process.

According to an exemplary embodiment of the present disclosure, the target situation where the data processing cannot be performed may include the following situations: a state of the first earphone changing from a worn state to a non-worn state, for example, the state of the first earphone changing from the worn state to a state of being taken off by a user (e.g., which can be determined by a determination between the first and second earphones of being more than a particular distance from each other, or by determining that one earphone is stationary while the other is moving); or a power amount (e.g., remaining battery power) of the first earphone being lower than a preset power amount threshold.

The scene determination module 1003 may determine a target scene where a user is currently located based on the acquired audio level, the acquired motion level and a preset correspondence, wherein the preset correspondence is a correspondence between a preset audio level, a preset motion level and a preset scene. The audio level may be, for example, one of or a combination of the noise level and the loudness level such as described previously. For example, if the audio level is a combination of the noise level and the loudness level, it may be an average level between the noise level and the loudness level, or if the average falls in the middle between two level states, may be selected as either the next higher level above the average or the next lower level below the average.

For example, the “preset audio level” and the “preset motion level” each may contain three levels, which are L0, L1 and L2, respectively. The “preset scene” may contain but is not limited to following scenes: reading, office working, moving, sports and others.

According to an exemplary embodiment of the present disclosure, the scene determination module 1003 may compare the acquired audio level with the preset audio level to obtain an audio level comparison result; and the scene determination module 1003 may compare the acquired motion level with the preset motion level to obtain a motion level comparison result. Then, the scene determination module 1003 may determine the target scene where the user is currently located based on the audio level comparison result, the motion level comparison result and the preset correspondence.

The feature value acquiring module 1004 may acquire an external environment feature value and/or a user behavior feature value in the target scene.

According to an exemplary embodiment of the present disclosure, the external environment feature value may be one or more of: an external audio data feature value, a distance feature value between earphones and a user terminal, etc.

The service providing module 1005 may provide the user with a service associated with the external environment feature value and/or the user behavior feature value.

According to an exemplary embodiment of the present disclosure, in the case where the external environment feature value is greater than or equal to a preset environment feature threshold, and/or in the case where the user behavior feature value is greater than or equal to a preset behavior feature threshold, the service providing module 1005 may provide the user with the service associated with the external environment feature value and/or the user behavior feature value.

For example, in the case where a user is currently in a reading scene, when it is detected that the user is sitting for a long time, a notification message for long sitting reminder may be sent to the user; in the case where the user is currently in an office working scene, when it is detected that there is another user having conversations with the current user, a conversation awareness may be output to the current user to remind the current user to reply to the conversations of the another user in time, or a volume of an audio currently played by the earphones may be decreased automatically to enable the user to hear the conversation contents between the another user and himself/herself more clearly; in the case where the user is in a moving scene, when it is detected that a distance between the earphones and the user terminal is relatively far, a notification message for phone loss prevention may be sent to the user; in the case where a user is currently in a sports scene, when it is detected that the user is excising intensely, a notification message that the intense exercise is harmful to the health may be sent to the user; and in the case where the user is currently in other scenes, when it is detected that the external audio is harsh and urgent (e.g., a sudden loud noise, especially if combined with a rapid change in motion), a harmful health event notification message may be sent to the user, for example, a notification message that an emergency situation occurs currently may be sent to the user and the like.

In the present disclosure, a multi-mode active perception monitoring method based on earphones is proposed, which may collect two types of data based on IMU sensors and audio microphones in the earphones, then perform fusion processing on the collected two types of data, and perceive an external environment in real time based on fusion processing results to provide active perception services to users. Since the types of data on which the provided services are based are more abundant, and the data contents are more comprehensive, the phenomenon of misjudgment may be reduced to a greater extent. Further, users can be provided with services that can satisfy the actual needs of the users, and service effect may be improved.

FIG. 11 is a block diagram illustrating an electronic device 1100 according to an exemplary embodiment of the present disclosure.

Referring to FIG. 11, the electronic device 1100 may include at least one memory 1101 and at least one processor 1102. The at least one memory 1101 stores instructions that, when executed by the at least one processor 1102, execute the method of providing the service according to exemplary embodiments of the present disclosure.

As an example, the electronic device 1100 may be a PC computer, a tablet device, a personal digital assistant, a smart phone, or any other device capable of executing the above indication set. Here, the electronic device 1100 does not have to be a single electronic device, and may also be any aggregate of devices or circuits that can execute the above-mentioned indications (or indication sets) individually or jointly, for example a smart phone coupled with two earphones. The electronic device 1100 may also be a part of an integrated control system or a system manager, or may be a portable electronic device configured to be interconnected with the local or remote (e.g., via wireless transmission) via interfaces.

In the electronic device 1100, the processor 1102 may include a central processing unit (CPU), a graphics processing unit (GPU), a programmable logic device, a dedicated processor system, a microcontroller, or a microprocessor. As an example rather than limitation, the processor may also include an analog processor, a digital processor, a microprocessor, a multi-core processor, a processor array, a network processor, and the like. When the electronic device 1100 includes a plurality of individually or jointly communicating devices, these various controllers and processors may be distributed among the plurality of devices.

The processor 1102 may run indications or codes stored in the memory 1101, wherein the memory 1101 may also store data. Instructions and data may also be transmitted and received over a network via a network interface device, wherein the network interface device may use any known transmission protocol.

The memory 1101 may be integrated with the processor 1102, for example, RAM or flash memory is arranged in an integrated circuit microprocessor or the like. In addition, the memory 1101 may include a separate device, such as an external disk drive, a storage array, or any other storage device that can be used by a database system. The memory 1101 and the processor 1102 may be operatively coupled, or may communicate with each other, for example, through an I/O port, a network connection or the like, so that the processor 1102 can read files stored in the memory.

In addition, the electronic device 1100 may also include a video display (such as a liquid crystal display) and a user interaction interface (such as a keyboard, a mouse, a touch input device, etc.). All components of the electronic apparatus 1100 may be connected to each other in a wired or wireless manner, for example, via a bus and/or a network.

According to an exemplary embodiment of the present disclosure, there is further provided a computer readable storage medium, wherein instructions in the computer readable storage medium, when executed by a processor of an electronic device, enable the electronic device to execute the above-described method of providing the service. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, Hard Disk Drive (HDD), Solid State Drive (SSD), card storage (such as, multimedia cards, secure digital (SD) cards or extreme speed digital (XD) cards), hard disks, solid state disks, and any other tangible devices that are configured to store computer programs and any associated data, data files and data structures in a non-transitory manner and provide the computer programs and any associated data, data files and data structures to the processor or computer so that the processor or computer may execute the computer programs. When the electronic device 1100 includes a plurality of individually or jointly communicating devices, these various storage media may be distributed among the plurality of devices. The instructions or computer programs in the above-mentioned computer-readable storage medium may run in an environment deployed in a computer apparatus such as a client, a host, an agent device, a server, or the like. In addition, in one example, the computer program and any associated data, data files and data structures are distributed on networked computer systems, so that the computer programs and any associated data, data files and data structures are stored, accessed, and executed in a distributed manner through one or more processors or computers.

According to an exemplary embodiment of the present disclosure, there may be further provided a computer program product including a computer program, wherein the computer program, when executed by a processor, implements the method of providing the service according to the present disclosure.

A method and apparatus of providing a service, an electronic device, a storage medium and a computer program product according to the present disclosure may provide users with services by comprehensively considering the external audio data and the user motion inertial data, such that the types of data on which the services are provided based are more abundant, and the data contents are more comprehensive. This may reduce the phenomenon of misjudgment to a greater extent, and further ensure that the users are provided with services that can satisfy the actual needs of the users, and may improve service effect.

According to the exemplary embodiments of the present disclosure, when both the earphones and the terminal are carried by the user, the earphones may further use the terminal to collect the external audio data and user motion inertial data, so that the earphones do not need to perform a collection task, thereby reducing a task pressure on the earphones. In addition, if the collection ability of the terminal is higher than that of the earphones, an accuracy of data collection may further be improved to further improve a service effect.

According to the exemplary embodiments of the present disclosure, by performing the fusion calibration on the data collected by two earphones, an amount of data that is considered is larger, and data information is more comprehensive, so that users may be provided with more accurate and more suitable services.

According to the exemplary embodiments of the present disclosure, by the means of averaging the audio data collected by the left and right earphones, comprehensively considering the audio data collected by the two earphones may be implemented to avoid a phenomenon in which poor service effectiveness is caused by performing data processing only based on the audio data collected by a single earphone. Therefore, more accurate services may be provided to the users.

According to the exemplary embodiments of the present disclosure, the audio data with a greater fluctuation amplitude may be discarded, and the data processing may only be performed based on the audio data with a smaller fluctuation amplitude, so that the data processing may be performed only based on the relatively more stable audio data. Interference on the accuracy of data processing caused by too large or too small abnormal values may be avoided, and the improvement of service effect may occur.

According to exemplary embodiments of the present disclosure, since prior values in historical processes have a certain reference value, sampling values having a change trend opposite to the historical prior values may be eliminated, and only sampling values with the same change trend as the historical change trend may be maintained for subsequent data processing. This may avoid the interference of abnormal sampling values on the accuracy of data processing and may further improve service effectiveness.

According to exemplary embodiments of the present disclosure, by controlling setting of the primary and secondary earphones, in some embodiments, only one earphone needs to be used to perform the main data processing process, and the other earphone can be used to only perform simple data processing or to even be in a standby state. This may effectively reduce power consumption. In addition, by providing a method of allowing the role switching between the primary and secondary earphones, the primary-secondary role switch may be performed in time in the case in which the current primary earphone does not work, and therefore, the other earphone may be converted to be a primary earphone in time to take over a task of the primary earphone that cannot work currently. Accordingly, alternative running of two earphones may be implemented based on an actual situation. A phenomenon of sudden interruption of data processing caused by the malfunction of one earphone may be avoided, and further continuous execution of data collection monitoring service may be ensured, thereby improving stability and anti-interference ability during the service provision process.

According to exemplary embodiments of the present disclosure, detection that the change rate of the user motion inertial data suddenly increases may indicate that a user has likely changed from a walking state to a running state. As the user moves rapidly, an external environment state and a user motion state will change drastically. As a result, higher requirements for sampling accuracy are also put forward. Therefore, high-rate IMU sampling and high-rate environmental sound sampling may be triggered to ensure the higher sampling accuracy to further ensure providing more accurate services to the user.

Those skilled in the art will easily conceive of other implementation solutions of the present disclosure after considering the description and practicing the invention disclosed herein. The present disclosure is intended to cover any modifications, uses, or adaptive changes of the present disclosure. These modifications, uses, or adaptive changes follow the general principles of the present disclosure and include common knowledge or customary technical means in the technical field that are not disclosed by the present disclosure. The description and the embodiments are only regarded as exemplary, and the true scope and spirit of the present disclosure are indicated by the claims below.

It should be understood that the present disclosure is not limited to the above-described accurate structures as illustrated in the accompanying drawings, and various modifications and changes may be made without departing from the scope thereof. The scope of the present disclosure is only defined by the appending claims.

What is claimed is:

1. A method of providing a service applied to earphones, comprising:
collecting external audio data and user motion inertial data;
determining an audio level corresponding to the external audio data, and determining a motion level corresponding to the user motion inertial data;
determining a target scene in which a user is currently located based on the determined audio level, the determined motion level and a preset correspondence, wherein the preset correspondence is a correspondence between a preset audio level, a preset motion level and a preset scene;
acquiring an external environment feature value and/or a user behavior feature value in the target scene; and
providing the user with a service associated with the external environment feature value and/or the user behavior feature value.

2. The method of claim 1, wherein the determining the audio level corresponding to the external audio data, comprises:
extracting a loudness feature value and/or a noise feature value from the external audio data; and
determining a loudness level corresponding to the external audio data based on the loudness feature value, and/or determining a noise level corresponding to the external audio data based on the noise feature value, wherein the greater the loudness feature value, the higher the loudness level, and the greater the noise feature value, the higher the noise level.

3. The method of claim 2, wherein:
the determined loudness level is one of a plurality of pre-defined loudness levels, each loudness level corresponding to a range of loudness feature values among a total range of loudness feature values for all of the pre-defined loudness levels, and
the determined noise level is one of a plurality of pre-defined noise levels, each noise level corresponding to a range of noise feature values among a total range of noise feature values for all of the pre-defined noise levels.

4. The method of claim 3, wherein the loudness level and the noise level is determined using a mapping table that correlates loudness feature values with loudness levels and noise feature values with noise levels.

5. The method of claim 2, wherein:
the earphones include two earphones; and
the collecting the external audio data and the user motion inertial data includes:
collecting the external audio data and the user motion inertial data for each of the two earphones; and
before determining the loudness level corresponding to the external audio data based on the loudness feature value, performing fusion calibration on loudness feature values respectively corresponding to the two earphones to obtain a fused loudness feature value, and/or performing fusion calibration on noise feature values respectively corresponding to the two earphones to obtain a fused noise feature value,
wherein:
the determining the loudness level corresponding to the external audio data based on the loudness feature value, and/or the determining the noise level corresponding to the external audio data based on the noise feature value includes determining the loudness level corresponding to the external audio data based on the fused loudness feature value, and/or determining the noise level corresponding to the external audio data based on the fused noise feature value.

6. The method of claim 5, further comprising, performing the fusion calibration by:
averaging the feature values respectively corresponding to the two earphones to take an obtained average value as a fused feature value; or
in the case where a fluctuation amplitude of the feature values collected by a first earphone of the two earphones is greater than or equal to a preset fluctuation threshold and a fluctuation amplitude of the feature values collected by a second earphone of the two earphones is less than the preset fluctuation threshold, discarding the feature values collected by the first earphone, and using the feature values collected by the second earphone as the fused feature values; or
in the case where a change trend of the feature values collected by the first earphone is opposite to a historical change trend and a change trend of the feature values collected by the second earphone is the same as the historical change trend, discarding the feature values collected by the first earphone, and using the feature values collected by the second earphone as the fused feature values, wherein the historical change trend is a change trend of feature values collected in a historical sampling phase before a current sampling phase of the earphones.

7. The method of claim 1, wherein the determining the target scene where the user is currently located based on the determined audio level, the acquired motion level, and the preset correspondence, comprises:
comparing the determined audio level with the preset audio level to obtain an audio level comparison result;
comparing the determined motion level with the preset motion level to obtain a motion level comparison result; and
determining the target scene in which the user is currently located based on the audio level comparison result, the motion level comparison result, and the preset correspondence.

8. The method of claim 1, wherein the collecting the external audio data and the user motion inertial data comprises:
collecting the external audio data and the user motion inertial data at a first sampling frequency;
before acquiring an audio level corresponding to the external audio data, and acquiring a motion level corresponding to the user motion inertial data, determining a change rate of the user motion inertial data collected at the first sampling frequency; and
in the case where the change rate of the user motion inertial data is greater than or equal to a preset rate threshold, collecting the external audio data and the user motion inertial data at a second sampling frequency, wherein the second sampling frequency is greater than the first sampling frequency; and
wherein the acquiring the audio level corresponding to the external audio data, and the acquiring the motion level corresponding to the user motion inertial data include acquiring an audio level corresponding to the external audio data collected at the second sampling frequency, and acquiring a motion level corresponding to the user motion inertial data collected at the second sampling frequency.

9. The method of claim 1, wherein the earphones include two earphones, and wherein the determining the audio level corresponding to the external audio data, and the determining the motion level corresponding to the user motion inertial data include:
using a first earphone of the two earphones to determine the audio level corresponding to the external audio data, and to determine the motion level corresponding to the user motion inertial data; and
in the case where it is detected that a target situation in which data processing cannot be performed happens to the first earphone, using a second earphone of the two earphones to determine the audio level corresponding to the external audio data, and to determine the motion level corresponding to the user motion inertial data.

10. The method of claim 9, wherein the target situation where the data processing cannot be performed includes at least one of:
a state of the first earphone changing from a worn state to a non-worn state, and a power amount of the first earphone being lower than a preset power amount threshold.

11. The method of claim 1, wherein the collecting the external audio data and the user motion inertial data comprises receiving the external audio data and the user motion inertial data collected by a user terminal.

12. The method of claim 1, wherein the providing the user with the service associated with the external environment feature value and/or the user behavior feature value, comprises:
in the case where the external environment feature value is greater than or equal to a preset environment feature threshold, and/or in the case where the user behavior feature value is greater than or equal to a preset behavior feature threshold, providing the user with the service associated with the external environment feature value and/or the user behavior feature value.

13. The method of claim 1, wherein the external environment feature value comprises an external audio data feature value, and a distance feature value between the earphones and a user terminal.

14. An electronic device, comprising:
a processor; and
a memory for storing instructions executable by the processor,
wherein the processor is configured to execute the instructions to implement the method for providing the service of claim 1.

15. A non-transitory computer readable storage medium, comprising instructions which, when executed by a processor of an electronic apparatus, enable the electronic apparatus to execute the method for providing the service of claim 1.

16. An apparatus for providing a service applied to earphones, comprising:
a first collection module configured to collect external audio data and user motion inertial data;
a level determining module configured to determine an audio level corresponding to the external audio data, and determine a motion level corresponding to the user motion inertial data;
a scene determination module configured to determine a target scene in which a user is currently located based on the determined audio level, the determined motion level and a preset correspondence, wherein the preset correspondence is a correspondence between a preset audio level, a preset motion level and a preset scene;
a feature value acquiring module configured to acquire an external environment feature value and/or a user behavior feature value in the target scene; and
a service providing module configured to provide the user with a service associated with the external environment feature value and/or the user behavior feature value.

17. The apparatus of claim 16, wherein the level determining module is configured to:
extract a loudness feature value and/or a noise feature value from the external audio data; and
determine a loudness level corresponding to the external audio data based on the loudness feature value, and/or determine a noise level corresponding to the external audio data based on the noise feature value, wherein the greater the loudness feature value, the higher the loudness level, and the greater the noise feature value, the higher the noise level.

18. The apparatus of claim 17, wherein the earphones include two earphones, and wherein the first collection module is configured to:
collect the external audio data and the user motion inertial data for each of the two earphones;
wherein the apparatus for providing the service further comprises:
a fusion calibration module configured to perform fusion calibration on loudness feature values respectively corresponding to the two earphones to obtain a fused loudness feature value, and/or perform fusion calibration on noise feature values respectively corresponding to the two earphones to obtain a fused noise feature value; and
wherein the level determining module is configured to:
determine the loudness level corresponding to the external audio data based on the fused loudness feature value, and/or determine the noise level corresponding to the external audio data based on the fused noise feature value.

19. The apparatus of claim 18, wherein the fusion calibration comprises:
averaging the feature values respectively corresponding to the two earphones to take an obtained average value as a fused feature value; or
in the case where a fluctuation amplitude of the feature values collected by a first earphone of the two earphones is greater than or equal to a preset fluctuation threshold and a fluctuation amplitude of the feature values collected by a second earphone of the two earphones is less than the preset fluctuation threshold, discarding the feature values collected by the first earphone, and taking the feature values collected by the second earphone as the fused feature value; or
in the case where a change trend of the feature values collected by the first earphone is opposite to a historical change trend and a change trend of the feature values collected by the second earphone is the same as the historical change trend, discarding the feature values collected by the first earphone, and taking the feature values collected by the second earphone as the fused feature values, wherein the historical change trend is a change trend of feature values collected in a historical sampling phase before a current sampling phase of the earphones.

20. The apparatus of claim 16, wherein the scene determination module is configured to:
compare the determined audio level with the preset audio level to obtain an audio level comparison result;
compare the determined motion level with the preset motion level to obtain a motion level comparison result; and
determine the target scene in which the user is currently located based on the audio level comparison result, the motion level comparison result, and the preset correspondence.
